(19) United States
(12) Patent Application Publication
(10) Pub. No.: US 2026/0270463 A1
(43) Pub. Date: Sep. 10, 2026

(54) BI-DIRECTIONAL OPTICAL FLOW

(71) Applicant: BEIJING DAJIA INTERNET INFORMATION TECHNOLOGY CO., LTD., BEIJING (CN)

(72) Inventors: Ning YAN, San Diego, CA (US); Xiaoyu XIU, San Diego, CA (US); Wei CHEN, San Diego, CA (US); Hong-Jheng JHU, San Diego, CA (US); Che-Wei KUO, San Diego, CA (US); Changyue MA, San Diego, CA (US); Xianglin WANG, San Diego, CA (US); Bing YU, Beijing (CN); Qi HUANG, Beijing (CN)

(21) Appl. No.: 19/658,423

(22) Filed: Apr. 24, 2026

Related U.S. Application Data
(63) Continuation of application No. PCT/CN2024/127494, filed on Oct. 25, 2024.
(60) Provisional application No. 63/593,505, filed on Oct. 26, 2023.
(60) Provisional application No. 63/597,291, filed on Nov. 8, 2023.
(60) Provisional application No. 63/610,332, filed on Dec. 14, 2023.

(30) Foreign Application Priority Data
Dec. 28, 2023 (WO) PCT/CN2023/142915

(51) Int. Cl. H04N 19/513; H04N 19/105; H04N 19/172; H04N 19/176

(52) U.S. Cl. CPC H04N 19/513; H04N 19/105; H04N 19/172; H04N 19/176

(57) ABSTRACT

A method for video decoding is provided. The method includes determining a first reference picture and/or a second reference picture associated with a current picture comprising a current block; determining an adaptive optical model used in an optical flow based refinement based on the first reference picture and/or the second reference picture; determining an adaptive sliding window size for the current block used in the optical flow based refinement; and deriving a respective motion refinement of each subblock of the current block based on the adaptive optical model and the adaptive sliding window.

### CROSS-REFERENCE TO RELATED APPLICATION

This application is a continuation of PCT Application No. PCT/CN2024/127494, which claims priority to Provisional Application No. 63/593,505 filed on Oct. 26, 2023, Provisional Application No. 63/597,291 filed on Nov. 8, 2023, Provisional Application No. 63/610,332 filed on Dec. 14, 2023, and PCT Application No. PCT/CN2023/142915 filed on Dec. 28, 2023, all disclosures of which are incorporated herein by reference in their entirety for all purposes.

### BACKGROUND

### Technical Field

This application is related to video coding and compression. More specifically, this application relates to improved bi-directional optical flow.

### Description of the Related Art

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. For example, video coding standards include Versatile Video Coding (VVC), Joint Exploration test Model (JEM), High-Efficiency Video Coding (HEVC/H.265), Advanced Video Coding (AVC/H.264), Moving Picture Expert Group (MPEG) coding, or the like. Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality.

### BRIEF SUMMARY

Embodiments of the present disclosure provide methods and apparatus for video coding.

According to a first aspect of the present disclosure, a method for video decoding is provided. The method includes determining a first reference picture and a second reference picture associated with a current picture comprising a current block; determining an adaptive optical model used in an optical flow based refinement based on the first reference picture and the second reference picture; determining an adaptive sliding window size for the current block used in the optical flow based refinement; and deriving a respective motion refinement of each subblock of the current block based on the adaptive optical model and the adaptive sliding window.

According to a second aspect of the present disclosure, a method for video encoding is provided. The method includes determining a first reference picture and a second reference picture associated with a current picture comprising a current block; determining an adaptive optical model used in an optical flow based refinement based on the first reference picture and the second reference picture; determining an adaptive sliding window size for the current block used in the optical flow based refinement; and deriving a respective motion refinement of each subblock of the current block based on the adaptive optical model and the adaptive sliding window.

According to a third aspect of the present disclosure, an electronic apparatus is provided. The electronic apparatus includes one or more processors; memory coupled to the one or more processors; and a plurality of programs stored in the memory that, when executed by the one or more processors, cause the electronic apparatus to receive video bitstream to perform the decoding method according to the embodiments of the present application or cause the electronic apparatus to perform the encoding method according to the embodiments of the present application to generate a video bitstream.

According to a fourth aspect of the present disclosure, a non-transitory computer readable storage medium is provided. The non-transitory computer readable storage medium stores a plurality of programs for execution by an electronic apparatus having one or more processors, wherein the plurality of programs, when executed by the one or more processors, cause the electronic apparatus to receive video bitstream to perform the decoding method according to the embodiments of the present application or cause the electronic apparatus to perform the encoding method according to the embodiments of the present application to generate a video bitstream.

It is to be understood that both the foregoing general description and the following detailed description are examples only and are not restrictive of the present disclosure.

### BRIEF DESCRIPTION OF THE SEVERAL VIEWS OF THE DRAWINGS

The accompanying drawings, which are incorporated in and constitute a part of this specification, illustrate examples consistent with the present disclosure and, together with the description, serve to explain the principles of the disclosure.

FIG. 1 is a block diagram illustrating an exemplary system for encoding and decoding video blocks in accordance with some implementations of the present disclosure.

FIG. 2 is a block diagram illustrating an exemplary video encoder in accordance with some implementations of the present disclosure.

FIG. 3 is a block diagram illustrating an exemplary video decoder in accordance with some implementations of the present disclosure.

FIGS. 4A through 4E are block diagrams illustrating how a frame is recursively partitioned into multiple video blocks of different sizes and shapes in accordance with some implementations of the present disclosure.

FIG. 5 is a diagram illustrating a computing environment coupled with a user interface, according to some implementations of the present disclosure.

FIG. 6 illustrates the Extended CU region used in BDOF.

FIG. 7 illustrates the process Decoding side motion vector refinement.

FIG. 8 illustrates the diamond regions in the search area in multi-pass DMVR.

FIG. 9 illustrates the proposed template matching based BDOF window size decision technique.

FIG. 10 is a flow chart illustrating a method for video decoding in accordance with some implementations of the present disclosure.

FIG. 11 is a flow chart illustrating a method for video encoding in accordance with some implementations of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But various alternatives may be used without departing from the scope of claims and the subject matter may be practiced without these specific details. For example, the subject matter presented herein can be implemented on many types of electronic devices with digital video capabilities.

It should be illustrated that the terms “first,” “second,” and the like used in the description, claims of the present disclosure, and the accompanying drawings are used to distinguish objects, and not used to describe any specific order or sequence. It should be understood that the data used in this way may be interchanged under an appropriate condition, such that the embodiments of the present disclosure described herein may be implemented in orders besides those shown in the accompanying drawings or described in the present disclosure.

Embodiments of the present disclosure provide methods and apparatus on improving the coding efficiency of the image/video blocks which applies bi-directional optical flow technology.

Embodiments of the present disclosure provide to decide the optimal BDOF window size at the encoder side and signal index of the optimal BDOF window size in the bitstream.

Embodiments of the present disclosure provide to decide the BDOF window size at the decoder side using template matching.

Embodiments of the present disclosure provide to enable BDOF for unit-prediction.

Embodiments of the present disclosure provide to extend BDOF for bi-prediction with template, including BDOF for non-true bi-prediction, BDOF for true bi-prediction with non-equal distance between the two reference pictures to the current picture.

Embodiments of the present disclosure provide additional optical flow sample refinement models for BDOF.

Embodiments of the present disclosure provide additional usage condition of BDOF.

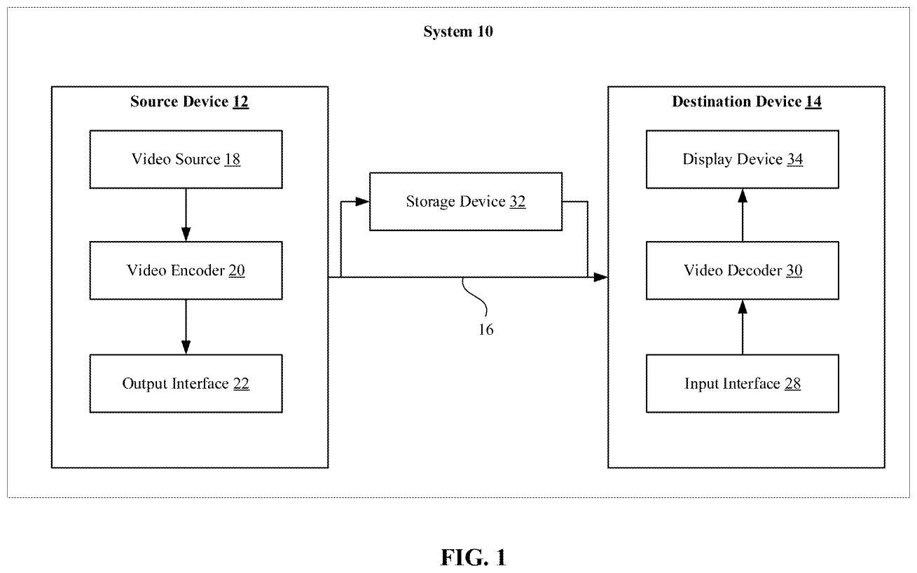

FIG. 1 is a block diagram illustrating an exemplary system 10 for encoding and decoding video blocks in parallel in accordance with some implementations of the present disclosure. As shown in FIG. 1, the system 10 includes a source device 12 that generates and encodes video data to be decoded at a later time by a destination device 14. The source device 12 and the destination device 14 may comprise any of a wide variety of electronic devices, including cloud servers, server computers, desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may comprise any type of communication medium or device capable of moving the encoded video data from the source device 12 to the destination device 14. In one example, the link 16 may comprise a communication medium to enable the source device 12 to transmit the encoded video data directly to the destination device 14 in real time. The encoded video data may be modulated according to a communication standard, such as a wireless communication protocol, and transmitted to the destination device 14. The communication medium may comprise any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter. The encoded video data may comprise a sequence of pictures, each of which may comprise one or more sample arrays, for example, luma (Y) only for monochrome; luma and two chroma in YCbCr or YCgCo domain; or green, blue, and red in GBR (also known as RGB) domain. For convenience of notation and terminology in this application, in some embodiments, variables and terms associated with each set of three sample arrays may be referred to as luma and chroma, where the two chroma arrays may be referred to as Cb and Cr, regardless of the actual color representation method in use. The video data may be in a chroma format of 4:0:0, 4:2:0, 4:2:2, or 4:4:4, but the present application is not limited thereto.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may comprise any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

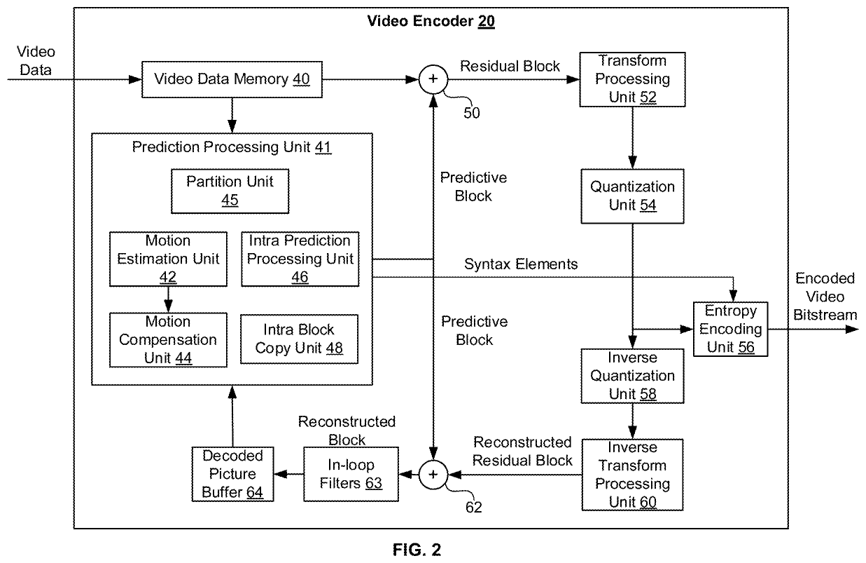

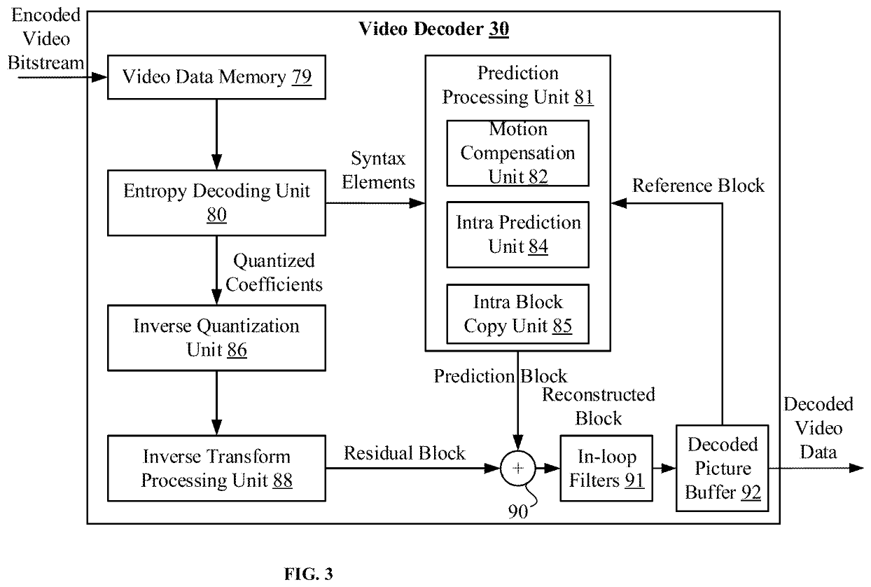

In some implementations, at least a part of components of the source device 12 (for example, the video source 18, the video encoder 20 or components included in the video encoder 20 as described below with reference to FIG. 2, and the output interface 22) and/or at least a part of components of the destination device 14 (for example, the input interface 28, the video decoder 30 or components included in the video decoder 30 as described below with reference to FIG. 3, and the display device 34) may operate in a cloud computing service network which may provide software, platforms, and/or infrastructure, such as Software as a Service (SaaS), Platform as a Service (PaaS), or Infrastructure as a Service (IaaS). In some implementations, one or more components in the source device 12 and/or the destination device 14 which are not included in the cloud computing service network may be provided in one or more client devices, and the one or more client devices may communicate with server computers in the cloud computing service network through a wireless communication network (for example, a cellular communication network, a short-range wireless communication network, or a global navigation satellite system (GNSS) communication network) or a wired communication network (e.g., a local area network (LAN) communication network or a power line communication (PLC) network). In an embodiment, at least a part of operations described herein may be implemented as cloud-based services provided by one or more server computers which are implemented by the at least a part of the components of the source device 12 and/or the at least a part of the components of the destination device 14 in the cloud computing service network; and one or more other operations described herein may be implemented by the one or more client devices. In some implementations, the cloud computing service network may be a private cloud, a public cloud, or a hybrid cloud. The terms such as “cloud,” “cloud computing,” “cloud-based,” etc., herein may be used interchangeably as appropriate without departing from the scope of the present disclosure. It should be understood that the present disclosure is not limited to being implemented in the cloud computing service network described above. Instead, the present disclosure may also be implemented in any other type of computing environments currently known or developed in the future.

FIG. 2 is a block diagram illustrating an exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 2, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter, Cross Component Sample Adaptive Offset (CCSAO) filter and/or Adaptive in-Loop Filter (ALF), may also be used in addition to the deblocking filter to filter an output of the summer 62. It should be illustrated that for the CCSAO technique, the present application is not limited to the embodiments described herein, and instead, the application may be applied to a situation where an offset is selected for any of a luma component and two chroma components (which may represent Y, Cb and Cr in YCbCr domain; Y, Cg and Co in YCgCo domain; or G, B and R in RGB domain for convenience of notation and terminology in this application as described above) according to any other of the luma component and the two chroma components to modify said any component based on the selected offset. Further, it should also be illustrated that a first component mentioned herein may be any of the luma component and the two chroma components, a second component mentioned herein may be any other of the luma component and the two chroma components, and a third component mentioned herein may be a remaining one of the luma component and the two chroma components. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 2, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1, or archived in the storage device 32 as shown in FIG. 1 for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 3 is a block diagram illustrating an exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 2. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 3. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter, CCSAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

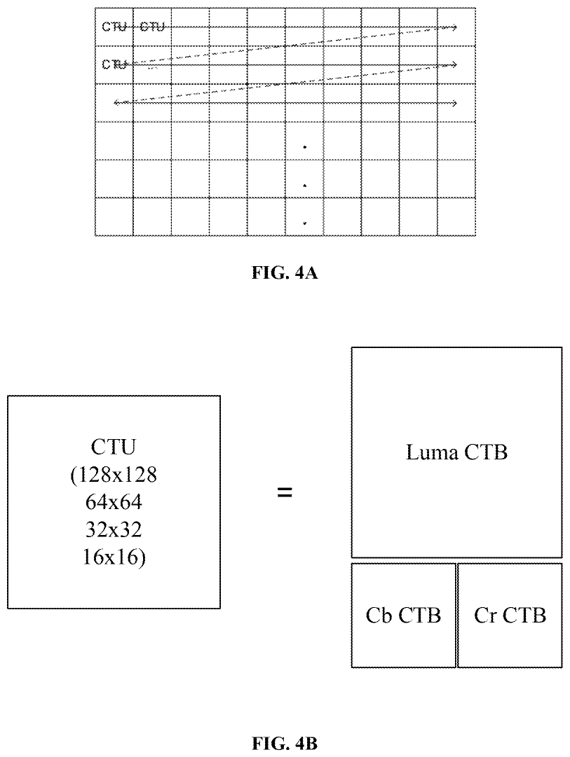

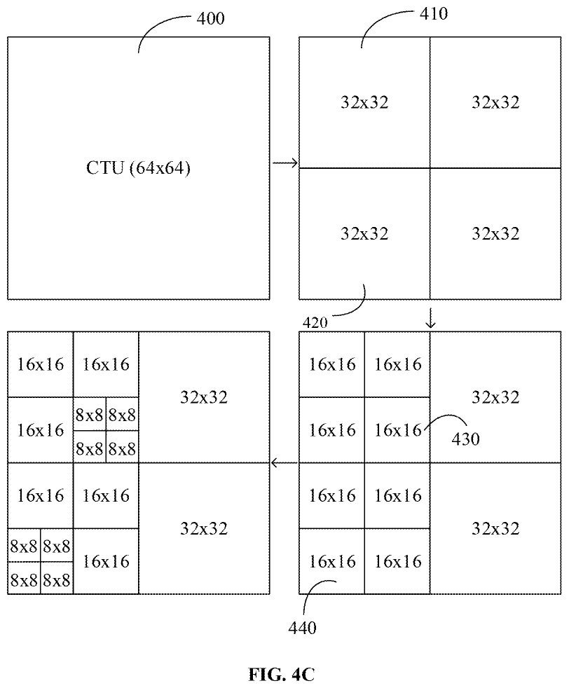

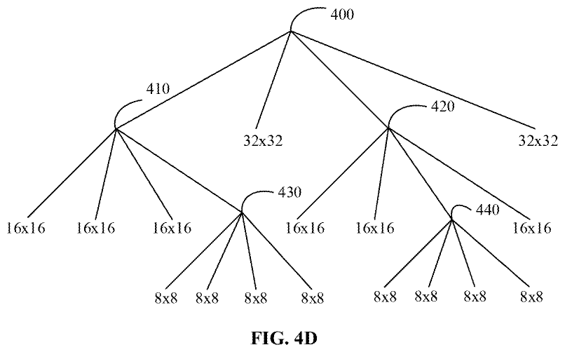

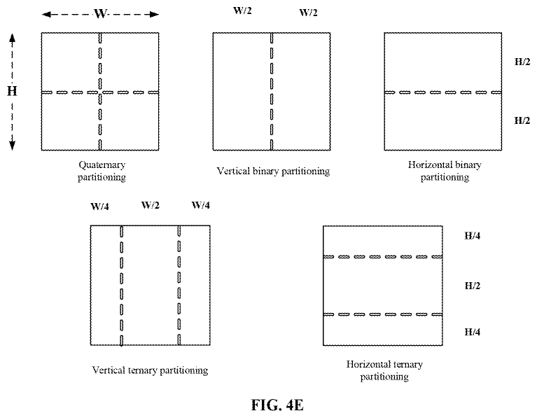

As shown in FIG. 4A, the video encoder 20 (or more specifically the partition unit 45) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 4B, each CTU may comprise one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may comprise a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 4C, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 4D depicts a quad-tree data structure illustrating the end result of the partition process of the CTU 400 as depicted in FIG. 4C, each leaf node of the quad-tree corresponding to one CU of a respective size ranging from 32×32 to 8×8. Like the CTU depicted in FIG. 4B, each CU may comprise a CB of luma samples and two corresponding coding blocks of chroma samples of a frame of the same size, and syntax elements used to code the samples of the coding blocks. In monochrome pictures or pictures having three separate color planes, a CU may comprise a single coding block and syntax structures used to code the samples of the coding block. It should be noted that the quad-tree partitioning depicted in FIGS. 4C and 4D is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIG. 4E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more M×N PBs. A PB is a rectangular (square or non-square) block of samples on which the same prediction, inter or intra, is applied. A PU of a CU may comprise a PB of luma samples, two corresponding PBs of chroma samples, and syntax elements used to predict the PBs. In monochrome pictures or pictures having three separate color planes, a PU may comprise a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 4C, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may comprise a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may comprise a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit 42 as described above in connection with FIG. 2, the motion vector predictor of the current CU is subtracted from the actual motion vector of the current CU to produce a Motion Vector Difference (MVD) for the current CU. By doing so, there is no need to encode the motion vector determined by the motion estimation unit 42 for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

### INTRODUCTION

In this section, bi-directional optical flow (BDOF) and its improvement methods are introduced.

### Principle of BDOF

Bi-directional optical flow (BDOF) technique is based on pixel level optical flow. Before introducing the design of BDOF in the VVC and ECM, the principle of BDOF is first introduced. Considering a pixel value at time t, the first order Taylor expansion is described as:

$$I ( t ) = I ( {t}_{0} ) + \frac{\partial I ( {t}_{0} )}{\partial t} ( t - {t}_{0} ) \qquad ( 1 )$$

Under the optical flow assumption, the following equations are satisfied.

$$\frac{dI}{dt} = \frac{\partial I}{\partial t} + \frac{\partial I}{\partial x} \cdot \frac{\partial x}{\partial t} + \frac{\partial I}{\partial y} \cdot \frac{\partial y}{\partial t} = 0 ⇒ \frac{\partial I}{\partial t} = - \frac{\partial I}{\partial x} \cdot \frac{\partial x}{\partial t} - \frac{\partial I}{\partial y} \cdot \frac{\partial y}{\partial t} \qquad ( 2 )$$

Let

$${G}_{x} = \frac{\partial I}{\partial x} and {G}_{y} = \frac{\partial I}{\partial y} ,$$

equation (2) is rewritten as:

$$\frac{\partial I}{\partial t} = - {G}_{x} \cdot \frac{\partial x}{\partial t} - {G}_{y} \cdot \frac{\partial y}{\partial t} \qquad ( 3 )$$

Equation (1) is converted as:

$$I ( t ) = I ( {t}_{0} ) - {G}_{{x}_{0}} \cdot \frac{\partial {x}_{0}}{\partial t} ( t - {t}_{0} ) - {G}_{{y}_{0}} \cdot \frac{\partial {y}_{0}}{\partial t} ( t - {t}_{0} ) \qquad ( 4 )$$

Noted that

$$\frac{\partial {x}_{0}}{\partial t} and \frac{\partial {y}_{0}}{\partial t}$$

are the motion speed along x and y directions and termed as:

$$\{ \begin{matrix}{V}_{{x}_{0}} = \frac{\partial {x}_{0}}{\partial t} \\ {V}_{{y}_{0}} = \frac{\partial {y}_{0}}{\partial t}\end{matrix} \qquad ( 6 )$$

Therefore, equation (4) becomes:

$$I ( t ) = I ( {t}_{0} ) - {G}_{{x}_{0}} \cdot {V}_{{x}_{0}} ( t - {t}_{0} ) - {G}_{{y}_{0}} \cdot {V}_{{y}_{0}} ( t - {t}_{0} ) \qquad ( 7 )$$

From the observation of equation (7), to estimate the pixel value at time t from time t₀, the Vₓ_{₀} and V_{y}_{₀} need to be estimated.

In the current VVC and ECM, BDOF is only applied to PU with true bi-prediction mode. Suppose that we have a forward reference picture at time t₀ and a backward reference picture at time t₁, and t−t₀=t₁−t=1.

So we have

$$\{ \begin{matrix}I ( t ) = I ( {t}_{0} ) - {G}_{{x}_{0}} \cdot {V}_{{x}_{0}} ( t - {t}_{0} ) - {G}_{{y}_{0}} \cdot {V}_{{y}_{0}} ( t - {t}_{0} ) = I ( {t}_{0} ) + {G}_{{x}_{0}} \cdot {V}_{{x}_{0}} + {G}_{{y}_{0}} \cdot {V}_{{y}_{0}} \\ I ( t ) = I ( {t}_{1} ) - {G}_{{x}_{1}} \cdot {V}_{{x}_{1}} ( t - {t}_{1} ) - {G}_{{y}_{1}} \cdot {V}_{{y}_{1}} ( t - {t}_{1} ) = I ( {t}_{1} ) - {G}_{{x}_{1}} \cdot {V}_{{x}_{1}} - {G}_{{y}_{1}} \cdot {V}_{{y}_{1}}\end{matrix} \qquad ( 8 )$$

For bi-prediction, the two reference samples are averaged as follow

$$I ( t ) = \frac{I ( {t}_{0} ) + I ( {t}_{1} )}{2} + \frac{( {G}_{{x}_{0}} \cdot {V}_{{x}_{0}} - {G}_{{x}_{1}} \cdot {V}_{{x}_{1}} ) + ( {G}_{{y}_{0}} \cdot {V}_{{y}_{0}} - {G}_{{y}_{1}} \cdot {V}_{{y}_{1}} )}{2} \qquad ( 9 )$$

Considering motion is along the trajectory, it is further assumed that Vₓ=Vₓ_{₀}=Vₓ_{₁} and V_{y}=V_{y}_{₀}=V_{y}_{₁}, equation (9) becomes

$$I ( t ) = \frac{I ( {t}_{0} ) + I ( {t}_{1} )}{2} + \frac{( {G}_{{x}_{0}} - {G}_{{x}_{1}} ) \cdot {V}_{x} + ( {G}_{{y}_{0}} - {G}_{{y}_{1}} ) \cdot {V}_{y}}{2} \qquad ( 10 )$$

To obtain Vₓ and V_{y}, bilateral matching is utilized by minimizing the following cost.

$$min \{ {\sum }_{Ω} {( ( I ( {t}_{0} ) + {G}_{{x}_{0}} \cdot {V}_{x} + {G}_{{y}_{0}} \cdot {V}_{y} ) - ( I ( {t}_{1} ) - {G}_{{x}_{1}} \cdot {V}_{x} - {G}_{{y}_{1}} \cdot {V}_{y} ) )}^{2} \} = min \{ {\sum }_{Ω} {( Δ I + ( {G}_{{x}_{0}} + {G}_{{x}_{1}} ) \cdot {V}_{x} + ( {G}_{{y}_{0}} + {G}_{{y}_{1}} ) \cdot {V}_{y} )}^{2} \} \qquad ( 11 )$$

Where Q is the region in the current PU.

### Design of BDOF in the VVC and ECM

The bi-directional optical flow (BDOF) tool is included in VVC. BDOF, previously referred to as BIO, was included in the JEM. Compared to the JEM version, the BDOF in VVC is a simpler version that requires much less computation, especially in terms of number of multiplications and the size of the multiplier.

BDOF is used to refine the bi-prediction signal of a CU at the 4×4 subblock level. BDOF is applied to a CU if it satisfies all the following conditions:

The CU is coded using “true” bi-prediction mode, i.e., one of the two reference pictures is prior to the current picture in display order and the other is after the current picture in display order.

The distances (i.e., POC difference) from two reference pictures to the current picture are same.

Both reference pictures are short-term reference pictures.

The CU is not coded using affine mode or the SbTMVP merge mode.

CU has more than 64 luma samples.

Both CU height and CU width are larger than or equal to 8 luma samples.

BCW weight index indicates equal weight.

WP is not enabled for the current CU.

CIIP mode is not used for the current CU.

BDOF is only applied to the luma component. As its name indicates, the BDOF mode is based on the optical flow concept, which assumes that the motion of an object is smooth. For each 4×4 subblock, a motion refinement (vₓ, V_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0, 1, of the two prediction signals are computed by directly calculating the difference between two neighboring samples, i.e.,

$$\{ \begin{matrix}\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) )\end{matrix} \qquad ( 12 )$$

where I^{(k)}(i, j) are the sample value at coordinate (i, j) of the prediction signal in list k, k=0,1, and shift1 is calculated based on the luma bit depth, bitDepth, as shift1=max(6, bitDepth−6).

Then, the auto- and cross-correlation of the gradients, S₁, S₂, S₃, S₅ and S₆, are calculated as

$$\{ \begin{matrix}{S}_{1} = {\sum }_{( i , j ) ∈ Ω} Abs ( {ψ}_{x} ( i , j ) ) \\ {S}_{3} = {\sum }_{( i , j ) ∈ Ω} θ ( i , j ) \cdot Sign ( {ψ}_{x} ( i , j ) ) \\ {S}_{2} = {\sum }_{( i , j ) ∈ Ω} {ψ}_{x} ( i , j ) \cdot Sign ( {ψ}_{y} ( i , j ) ) \\ {S}_{5} = {\sum }_{( i , j ) ∈ Ω} Abs ( {ψ}_{y} ( i , j ) ) \\ {S}_{5} = {\sum }_{( i , j ) ∈ Ω} Abs ( {ψ}_{y} ( i , j ) )\end{matrix} \qquad ( 13 )$$

where

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \qquad ( 14 )$$

$${ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \qquad ( 15 )$$

$$θ ( i , j ) = ( {I}^{( 1 )} ( i , j ) ≫ {n}_{b} ) - ( {I}^{( 0 )} ( i , j ) ≫ {n}_{b} ) \qquad ( 16 )$$

where Ω is a 6×6 window around the 4×4 subblock, and the values of nₐ and n_{b} are set equal to min(1, bitDepth−11) and min(4, bitDepth−8), respectively.

The motion refinement (vₓ, V_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) \text{:} 0 \qquad ( 17 )$$

$${v}_{y} = {S}_{5} > 0 ? clip 3 ( - {th}_{BIO}^{′} , {th}_{BIO}^{′} - ( ( {S}_{6} \cdot {2}^{{n}_{b} - {n}_{a}} - ( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) \text{:} 0 \qquad ( 18 )$$

where

$${S}_{2 , m} = {S}_{2} ≫ {n}_{{S}_{2}} , {s}_{2 , s} = {S}_{2} \& ( {2}^{{n}_{{S}_{2}}} - 1 ) , t {h}_{BIO}^{′} = {2}^{max ( 5 , BD - 7 )} .$$

└⋅┘ is the floor function, and n_{S}_{₂}=12.

Based on the motion refinement and the gradients, the following adjustment is calculated for each sample in the 4×4 subblock:

$$b ( x , y ) = rnd ( \frac{\begin{matrix}( {v}_{x} ( \frac{\partial {I}^{( 1 )} ( x , y )}{\partial x} - \frac{\partial {I}^{( 0 )} ( x , y )}{\partial x} ) + \\ {v}_{y} ( \frac{\partial {I}^{( 1 )} ( x , y )}{\partial y} - \frac{\partial {I}^{( 0 )} ( x , y )}{\partial y} ) + 1 )\end{matrix}}{2} ) \qquad ( 19 )$$

Finally, the BDOF samples of the CU are calculated by adjusting the bi-prediction samples as follows:

$${pred}_{B D O F} ( x , y ) = ( {I}^{( 0 )} ( x , y ) + {I}^{( 1 )} ( x , y ) + b ( x , y ) + {o}_{offset} ) ≫ shift \qquad ( 20 )$$

These values are selected such that the multipliers in the BDOF process do not exceed 15-bit, and the maximum bit-width of the intermediate parameters in the BDOF process is kept within 32-bit.

In order to derive the gradient values, some prediction samples I^{(k)}(i, j) in list k (k=0,1) outside of the current CU boundaries need to be generated. As depicted in FIG. 6, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor (.) operation on the coordinates) directly without interpolation, and the normal 8-tap motion compensation interpolation filter is used to generate prediction samples within the CU (dotted positions). These extended sample values are used in gradient calculation only. For the remaining steps in the BDOF process, if any sample and gradient values outside of the CU boundaries are needed, they are padded (i.e., repeated) from their nearest neighbors.

When the width and/or height of a CU are larger than 16 luma samples, it will be split into subblocks with width and/or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*H>>1), where W indicates the subblock width, and H indicates subblock height. To avoid the additional complexity of SAD calculation, the SAD between the initial L0 and L1 prediction samples calculated in DVMR process is re-used here.

If BCW is enabled for the current block, i.e., the BCW weight index indicates unequal weight, then bi-directional optical flow is disabled. Similarly, if WP is enabled for the current block, i.e., the luma_weight_lx flag is 1 for either of the two reference pictures, then BDOF is also disabled. When a CU is coded with symmetric MVD mode or CIIP mode, BDOF is also disabled.

### (1) Sample-Based BDOF

In the ECM, sample-based BDOF is utilized. In the sample-based BDOF, instead of deriving motion refinement (Vx, Vy) on a block basis, it is performed per sample.

The coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive Vx and Vy. The derived motion refinement (Vx, Vy) is applied to adjust the bi-predicted sample value for the center sample of the window.

### Decoder Side Motion Vector Refinement (DMVR)

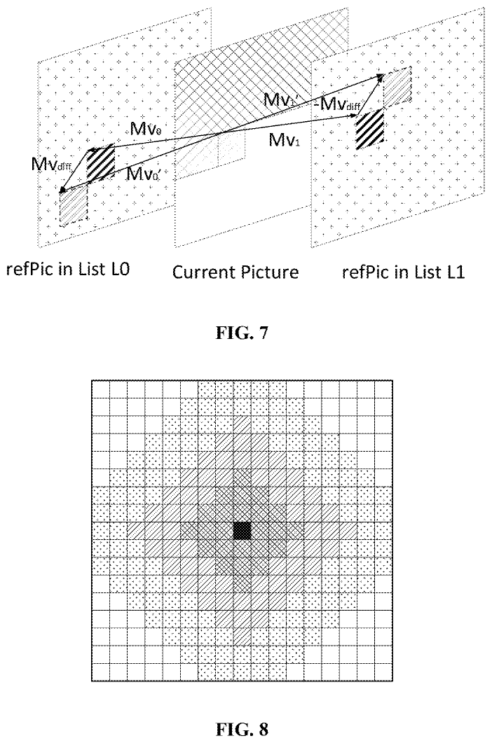

In order to increase the accuracy of the MVs of the merge mode, a bilateral-matching (BM) based decoder side motion vector refinement is applied in VVC. In bi-prediction operation, a refined MV is searched around the initial MVs in the reference picture list L0 and reference picture list L1. The BM method calculates the distortion between the two candidate blocks in the reference picture list L0 and list L1. As illustrated in FIG. 7, the SAD between the dashed blocks based on each MV candidate around the initial MV is calculated. The MV candidate with the lowest SAD becomes the refined MV and used to generate the bi-predicted signal.

In VVC, the application of DMVR is restricted and is only applied for the CUs which are coded with following modes and features:

CU level merge mode with bi-prediction MV.

One reference picture is in the past and another reference picture is in the future with respect to the current picture.

The distances (i.e., POC difference) from two reference pictures to the current picture are same.

Both reference pictures are short-term reference pictures.

CU has more than 64 luma samples.

Both CU height and CU width are larger than or equal to 8 luma samples.

BCW weight index indicates equal weight.

WP is not enabled for the current block.

CIIP mode is not used for the current block.

The refined MV derived by DMVR process is used to generate the inter prediction samples and also used in temporal motion vector prediction for future pictures coding. While the original MV is used in deblocking process and also used in spatial motion vector prediction for future CU coding.

### (1) Searching Scheme

In DVMR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + {MV}_{offset} \qquad ( 21 )$$

$$MV {1}^{′} = MV 1 + {MV}_{offset} \qquad ( 22 )$$

Where MV_{offset} represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form

$$E ( x , y ) = {A ( x - {x}_{min} )}^{2} + {B ( y - {y}_{min} )}^{2} + C \qquad ( 23 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = \frac{E ( - 1 , 0 ) - E ( 1 , 0 )}{2 ( E ( - 1 , 0 ) + E ( 1 , 0 ) - 2 E ( 0 , 0 ) )} \qquad ( 24 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 25 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ, yₘᵢₙ) are added to the integer distance refinement MV to get the sub-pixel accurate refinement delta MV.

### (2) Bilinear-Interpolation and Sample Padding

In VVC, the resolution of the MVs is 1/16 luma samples. The samples at the fractional position are interpolated using a 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DVMR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

### (3) Maximum DMVR Processing Unit

When the width and/or height of a CU are larger than 16 luma samples, it will be further split into subblocks with width and/or height equal to 16 luma samples. The maximum unit size for DMVR searching process is limit to 16×16.

### Multi-Pass Decoder-Side Motion Vector Refinement

A multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

### (1) First Pass—Block Based Bilateral Matching MV Refinement

In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated as: bilCost=mvDistanceCost+sadCost. When the block size cbW*cbH is greater than 64, mean-removal SAD (MRSAD) cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV 0 \_pass 1 = MV 0 + deltaMV$$

$$MV 1 \_pass 1 = MV 1 - deltaMV$$

### (2) Second Pass-Subblock Based Bilateral Matching MV Refinement

In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2(sbIdx2) and MV1_pass2(sbIdx2)) are derived based on the minimum bilateral matching cost between the two reference subblocks in L0 and L1.

For each subblock, BM performs full search to derive integer sample precision intDeltaMV. The full search has a search range [−sHor, sHor] in horizontal direction and [−sVer, sVer] in vertical direction, wherein, the values of sHor and sVer are determined by the block dimension, and the maximum value of sHor and sVer is 8.

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 8. Each search region is assigned a costFactor, which is determined by the distance (intDeltaMV) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV(sbIdx2). The refined MVs at second pass is then derived as:

$$MV 0 \_pass 2 ( sbIdx 2 ) = MV 0 \_pass 1 + deltaMV ( sbIdx 2 )$$

$$MV 1 \_pass 2 ( sbIdx 2 ) = MV 1 \_pass 1 - deltaMV ( sbIdx 2 )$$

### (3) Third Pass—Subblock Based Bi-Directional Optical Flow MV Refinement

In the third pass, a refined MV is derived by applying BDOF to an 8×8 grid subblock. For each 8×8 subblock, BDOF refinement is applied to derive scaled Vₓ and V_{y} without clipping starting from the refined MV of the parent subblock of the second pass. The derived bioMv(Vₓ, V_{y}) is rounded to 1/16 sample precision and clipped between −32 and 32.

The refined MVs (MV0_pass3 (sbIdx3) and MV1_pass3 (sbIdx3)) at third pass are derived as:

$$MV 0 \_pass 3 ( sbIdx 3 ) = MV 0 \_pass 2 ( sbIdx 2 ) + bioMv$$

$$MV 1 \_pass 3 ( sbIdx 3 ) = MV 0 \_pass 2 ( sbIdx 2 ) - bioMv$$

In all aforementioned sub-clauses, when wrap around motion compensation is enabled, the motion vectors shall be clipped with wrap around offset taken into consideration.

### Problem Statement

In the current ECM, sample-based BDOF is utilized. For every sample in the subblock, a sliding 5×5 window is used and the BDOF process is applied for every sliding window to derive motion refinement. The following deficiencies that exist in the current BDOF technique are identified in this disclosure.

Firstly, in the ECM, fixed 5×5 sliding window is applied in BDOF which may not adapt to the diverse video characteristics.

Secondly, in the current VVC and ECM, BDOF is only applied to the prediction units satisfying the two conditions: The CU is coded using “true” bi-prediction mode, i.e., one of the two reference pictures is prior to the current picture in display order and the other is after the current picture in display order. Also, the distances (i.e., POC difference) from two reference pictures to the current picture are same. However, prediction sample refinement with optical flow for uni-prediction is not considered. Also, the BDOF is not applied to the cases of
True bi-prediction with non-equal distance between reference pictures to the current picture and
Bi-prediction with two reference pictures having smaller POC values than the current picture, i.e., low-delay case.

### Proposed Method

It should be noted that the following methods may be applied independently or combinedly.

### Adaptive BDOF Window Size

In this disclosure, adaptive sliding window size are proposed for BDOF. For each block, the sliding window size used to derive the motion refinement is adaptively decided and applied.

In one embodiment, the sliding window size are explicitly derived and signaled in the bitstream. At the encoder side, several sliding window size candidates are tested and selected for each prediction unit (PU) using rate-distortion optimization. The index for the optimal sliding window size is signaled in the bitstream.

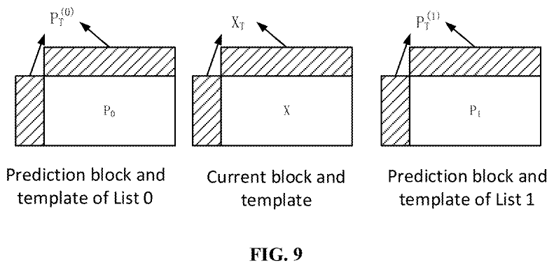

In yet another embodiment, the sliding window size are implicitly derived at the decoder side with template matching, therefore no further signaling overhead is needed. The proposed template matching based sliding window size is illustrated in FIG. 9. Firstly, the predicted template of reference list 0 and list 1 are obtained

$$( {P}_{T}^{( 0 )} and {P}_{T}^{( 1 )}$$

in FIG. 9). Then BDOF process is applied to

$${P}_{T}^{( 0 )} and {P}_{T}^{( 1 )}$$

with a certain sliding window size candidate. Finally, the template matching cost is calculated which measures the distance between the predicted block after BDOF process and the template of the current block X_{T}. The sliding window size candidate which leads to the minimum template matching cost is selected and applied to the BDOF process of the current block.

### Uni-Directional Optical Flow (UDOF)

In this disclosure, it is proposed to extend the optical flow-based sample refinement to uni-prediction, termed as uni-directional optical flow (UDOF). According to equation (7), to obtain the refined sample value at time t from time t₀, Vₓ_{₀} and V_{y}_{₀} needs to be estimated. In the BDOF, bilateral matching is exploited to estimate Vₓ_{₀} and V_{y}_{₀} by minimizing the difference between the refined samples of the two directions. To enable optical flow-based sample refinement for uni-prediction, it is proposed to utilize template to estimate Vₓ_{₀} and V_{y}_{₀}.

Denote the neighboring reconstructed template of the current PU at time t as

$${I}_{cur}^{T} ,$$

the corresponding reference template at time t₀ as I^{T}(t₀). Applying equation (7) to the template, the refined reference template is obtained as follow.

$${I}^{T} ( t ) = {I}^{T} ( {t}_{0} ) - {G}_{{x}_{0}}^{T} \cdot {V}_{{x}_{0}}^{T} ( t - {t}_{0} ) - {G}_{{y}_{0}}^{T} \cdot {V}_{{y}_{0}}^{T} ( t - {t}_{0} ) \qquad ( 26 )$$

Suppose that t−t₀=1, equation (26) becomes

$${I}^{T} ( t ) = {I}^{T} ( {t}_{0} ) - {G}_{{x}_{0}}^{T} \cdot {V}_{{x}_{0}}^{T} - {G}_{{y}_{0}}^{T} \cdot {V}_{{y}_{0}}^{T} \qquad ( 27 )$$

Then

$${V}_{{x}_{0}}^{T} and {V}_{{y}_{0}}^{T}$$

are solved by minimizing the difference between I^{T}(y) and

$${I}_{cur}^{T} .$$

$$min \{ {\sum }_{{Ω}^{T}} {( {I}_{cur}^{T} - {I}^{T} ( {t}_{0} ) + {G}_{{x}_{0}}^{T} \cdot {V}_{{x}_{0}}^{T} + {G}_{{y}_{0}}^{T} \cdot {V}_{{y}_{0}}^{T} )}^{2} \} \qquad ( 28 )$$

where Ω^{T} represent the region in the template. The solved

$${V}_{{x}_{0}}^{T} and {V}_{{y}_{0}}^{T}$$

are applied to the current PU, i.e.,

$${V}_{{x}_{0}} = {V}_{{x}_{0}}^{T} and {V}_{{y}_{0}} = {V}_{{y}_{0}}^{T} .$$

The refined samples for uni-prediction are obtained as follow.

$$I ( t ) = I ( {t}_{0} ) - {G}_{{x}_{0}} \cdot {V}_{{x}_{0}} - {G}_{{y}_{0}} \cdot {V}_{{y}_{0}} \qquad ( 29 )$$

### Template-Based BDOF

In this disclosure, BDOF is extended to more general bi-prediction cases by exploiting template matching technique.

According to one or more embodiment of this disclosure, BDOF is applied to bi-prediction of low-delay cases, i.e., both the two reference pictures have smaller POC values than the current picture.

According to one or more embodiment of this disclosure, BDOF is applied to true bi-prediction with the distances from two reference pictures to the current picture are different.

According to one or more embodiment of this disclosure, it is proposed to apply template matching to solve V_{y} and V_{y} in equation (10) in BDOF. Denote the neighboring reconstructed template of the current PU at time t as

$${I}_{cur}^{T} ,$$

the corresponding reference template at time t₀ and t₁ as I^{T}(t₀) and I^{T}(t₁). By applying equation (10) to the template, the predicted template is obtained as follow.

$${I}^{T} ( t ) = \frac{{I}^{T} ( {t}_{0} ) + {I}^{T} ( {t}_{1} )}{2} + \frac{( {G}_{{x}_{0}}^{T} - {G}_{{x}_{1}}^{T} ) \cdot {V}_{x}^{T} + ( {G}_{{y}_{0}}^{T} - {G}_{{y}_{1}}^{T} ) \cdot {V}_{y}^{T}}{2} \qquad ( 30 )$$

Then

$${V}_{x}^{T} and {V}_{y}^{T}$$

are solved by minimizing the difference between I^{t}(t) and

$${I}_{c u r}^{T} .$$

$$min \{ {\sum }_{{Ω}^{T}} {( {I}_{c u r}^{T} - \frac{{I}^{T} ( {t}_{0} ) + {I}^{T} ( {t}_{1} )}{2} - \frac{( {G}_{{x}_{0}}^{T} - {G}_{{x}_{1}}^{T} ) \cdot {V}_{x}^{T} + ( {G}_{{y}_{0}}^{T} - {G}_{{y}_{1}}^{T} ) \cdot {V}_{y}^{T}}{2} )}^{2} \} \qquad ( 28 )$$

where Ω^{T} represent the region in the template.

The solved

$${V}_{{x}_{0}}^{T} and {V}_{{y}_{0}}^{T}$$

are applied to the current PU, i.e.,

$${V}_{x} = {V}_{x}^{T} and {V}_{y} = {V}_{y}^{T} .$$

Then Vₓ and V_{y} are applied to equation (10) to obtain the refined samples.

It should be noted that the proposed TM-based BDOF is applicable to the following three cases.

Bi-prediction of low-delay cases, i.e., both the two reference pictures have smaller POC values than the current picture.

True bi-prediction with the distances from two reference pictures to the current picture are different.

True bi-prediction with the distances from two reference pictures to the current picture are the same.

### Adaptive Optical Model Selection for BDOF

In the current VVC and ECM, the optical flow sample refinement processes of both directions are utilized for bi-predicted block by minimizing the bilateral matching cost. Due to the diversity of video content, such optical flow refinement method may be not always effective for certain prediction block.

According to the present disclosure, additional optical flow sample refinement models may be introduced to bi-prediction. More specifically, the optical flow sample refinement may be applied only to either the forward reference block or the backward reference block instead of both reference blocks, i.e., three optical flow sample refinement methods are defined. The bi-directional optical flow sample refinement model could be described as equation (9). The uni-directional optical flow sample refinement method is conducted as the following equation.

$$I ( t ) = \frac{I ( {t}_{i} ) + ( {G}_{{x}_{i}} \cdot {V}_{{x}_{i}} + {G}_{{y}_{i}} \cdot {V}_{{y}_{i}} ) + I ( {t}_{1 - i} )}{2} \qquad ( 29 )$$

where i indicates the direction the optical flow refinement is applied to, where i=0 or 1.

In one embodiment, Vₓ_{ᵢ} and V_{y}_{ᵢ} are solved using bilateral matching as follow.

$$min \{ {\sum }_{Ω} ( I ( {t}_{i} ) + {( {G}_{{x}_{i}} \cdot {V}_{{x}_{i}} + {G}_{{y}_{i}} \cdot {V}_{{y}_{i}} - I ( {t}_{1 - i} ) )}^{2} \} \qquad ( 30 )$$

In yet another embodiment, Vₓ_{ᵢ} and V_{y}_{ᵢ} are solved using template matching as follow.

$$min \{ {\sum }_{{Ω}^{T}} {( {I}_{c u r}^{T} - \frac{{I}^{T} ( {t}_{i} ) + ( {G}_{{x}_{i}}^{T} + {G}_{{y}_{i}}^{T} ) + {I}^{T} ( {t}_{1 - i} )}{2} )}^{2} \} \qquad ( 31 )$$

According to the present disclosure, the usage of the above-mentioned three optical flow sample refinement models could be explicitly signaled or implicitly derived.

In the explicit signaling method, the three models are checked at the encoder side and the model leading to the minimum rate-distortion cost is selected and signaled.

In the implicit derivation method, the three models are applied to the template, the model leading to minimum template cost is selected and applied to the current block.

### Template-Based BDOF Usage Condition

According to the present disclosure, for prediction blocks satisfying the current BDOF condition, addition condition is added by using template.

Firstly, motion compensation is conducted for the template without BDOF using the motion information of the current block. The distance between the predicted template and the template of the current block is calculated as the template cost, denoted as cost1.

Secondly, motion compensation is conducted for the template with BDOF using the motion information of the current block. The distance between the predicted template and the template of the current block is calculated as the template cost, denoted as cost2.

If cost1<cost2, BDOF is not applied to the current block and vice versa.

According to the present disclosure, some BDOF usage conditions may be removed or relaxed when template-based usage condition is exploited.

According to one additional example of the disclosure, the BDOF may be applicable for prediction block coded with reference pictures from the same directions.

According to the second additional example of the disclosure, the BDOF may be applicable for prediction block of which the distances (i.e., POC difference) from two reference pictures to the current picture are different.

BDOF with Unequal Reference Distance

According to one or more embodiments of this disclosure, BDOF with unequal reference picture distances is enabled, where the distances (i.e., POC differences) from two reference pictures to the current picture are different.

In the first method, POC distance is considered when solving and applying vₓ and v_{y} in equation (12)~equation (20). Denote the POC of the current picture as poc, the POC values of the two reference pictures as poc0 and poc1. Two scaling factors are calculated using the two POC distances as follow.

$$if abs ( poc 1 - poc ) > abs ( poc 0 - poc ) , s 0 = ( abs ( poc 0 - poc ) << S ) / abs ( poc 1 - poc ) and s 1 = ( 1 << S )$$

$$if abs ( poc 1 - poc ) < abs ( poc 0 - poc ) , s 1 = ( abs ( poc 1 - poc ) << S ) / abs ( poc 0 - poc ) and s 0 = ( 1 << S )$$

where abs(.) is used to calculate absolute value, S is the shift number to represent the scaling factors with integer.

$$\frac{\partial {I}^{( 0 )}}{\partial x} ( i , j ) , \frac{\partial {I}^{( 1 )}}{\partial x} ( i , j ) , \frac{\partial {I}^{( 0 )}}{\partial y} ( i , j ) and \frac{\partial {I}^{( 1 )}}{\partial y} ( i , j )$$

in equation (12) are left shifted by S.

$$\{ \begin{matrix}\frac{\partial {I}^{( k )}}{\partial x} ( i , j ) = ( ( {I}^{( k )} ( i + 1 , j ) >> shift 1 ) - \\ ( {I}^{( k )} ( i - 1 , j ) >> shift 1 ) ) << S \\ \frac{\partial {I}^{( k )}}{\partial y} ( i , j ) = ( ( {I}^{( k )} ( i , j + 1 ) >> shift 1 ) - \\ ( {I}^{( k )} ( i , j - 1 ) >> shift 1 ) ) << S\end{matrix} \qquad ( 32 )$$

In addition, θ(i, j) in equation (16) is also left shifted by S.

$$θ ( i , j ) = ( ( {I}^{( 1 )} ( i , j ) >> {n}_{b} ) - ( {I}^{( 0 )} ( i , j ) >> {n}_{b} ) ) << S \qquad ( 33 )$$

The final prediction is obtained in the following manner.

$${pred}_{BDOF} ( x , y ) = ( ( {I}^{( 0 )} ( x , y ) + {I}^{( 1 )} ( x , y ) + {o}_{offset} ) << S + b ( x , y ) ) >> ( shift + S ) \qquad ( 34 )$$

In the second method, vₓ and v_{y} are firstly solved using equation (12)~equation (18) as in the ECM and then scaled using POC distances. Two scaling factors are calculated using the two POC distances as follow.

$$a ) if abs ( poc 1 - poc ) > abs ( poc 0 - poc ) , s 0 = ( abs ( poc 0 - poc ) << S ) / abs ( poc 1 - poc ) and s 1 = ( 1 << S )$$

$$b ) if abs ( poc 1 - poc ) < abs ( poc 0 - poc ) , s 1 = ( abs ( poc 1 - poc ) << S ) / abs ( poc 0 - poc ) and s 0 = ( 1 << S )$$

where S is the shift number to represent the scaling factors with integer.

vₓ and v_{y} are scaled with s0 and s1 to obtain the motion refinement for the two reference pictures.

$$\{ \begin{matrix}{v}_{x 0} = ( ( 1 << S ) * {v}_{x} + ( 1 << ( S - 1 ) ) - ( ( 1 << S ) * {v}_{x} \geq 0 ) ) >> S \\ {v}_{y 0} = ( ( 1 << S ) * {v}_{y} + ( 1 << ( S - 1 ) ) - ( ( 1 << S ) * {v}_{y} \geq 0 ) ) >> S \\ {v}_{x 1} = ( ( 1 << S ) * {v}_{x 1} + ( 1 << ( S - 1 ) ) - ( ( 1 << S ) * {v}_{x 1} \geq 0 ) ) >> S \\ {v}_{y 1} = ( ( 1 << S ) * {v}_{y 1} + ( 1 << ( S - 1 ) ) - ( ( 1 << S ) * {v}_{y 1} >= 0 ) ) >> S\end{matrix} \qquad ( 35 )$$

The refinement value is calculated as follow.

$$b ( x , y ) = rnd ( \frac{\begin{matrix}( {ν}_{x 1} \cdot \frac{\partial {I}^{( 1 )} ( x , y )}{\partial x} - {ν}_{x 0} \cdot \frac{\partial {I}^{( 0 )} ( x , y )}{\partial x} + \\ {ν}_{y 1} \cdot \frac{\partial {I}^{( 1 )} ( x , y )}{\partial y} - {ν}_{y 0} \cdot \frac{\partial {I}^{( 0 )} ( x , y )}{\partial y} + 1 )\end{matrix}}{2} ) \qquad ( 36 )$$

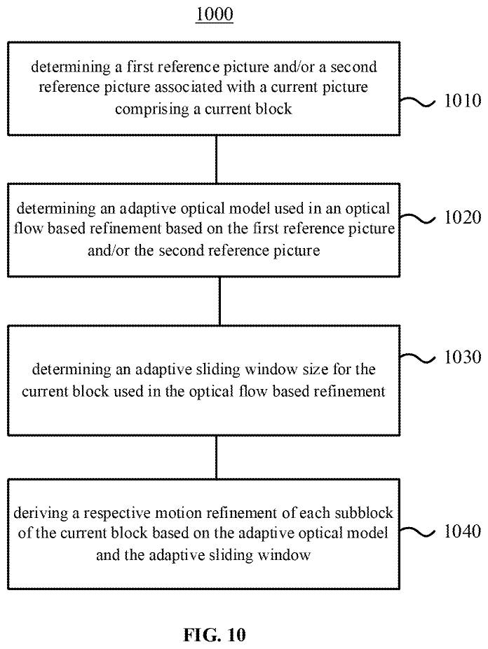

FIG. 10 is a flow chart illustrating a method 1000 for video decoding in accordance with some implementations of the present disclosure. The method 1000 may be performed by a video decoder, for example, the video decoder 30. As shown in FIG. 10, the method 1000 comprises steps 1010, 1020, 1030 and 1040.

In step 1010, the video decoder determines a first reference picture and/or a second reference picture associated with a current picture comprising a current block.

In step 1020, the video decoder determines an adaptive optical model used in an optical flow based refinement based on the first reference picture and the second reference picture.

In step 1030, the video decoder determines an adaptive sliding window size for the current block used in the optical flow based refinement.

In step 1040, the video decoder derives a respective motion refinement of each subblock of the current block based on the adaptive optical model and the adaptive sliding window.

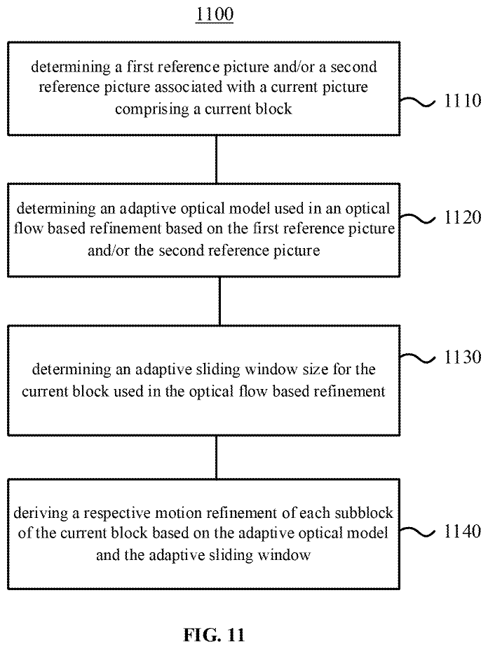

FIG. 11 is a flow chart illustrating a method 1100 for video encoding in accordance with some implementations of the present disclosure. The method 1100 may be performed by a video encoder, for example, the video encoder 20. As shown in FIG. 1100, the method 1100 comprises steps 1110, 1120, 1130 and 1140.

In step 1110, the video encoder, the video encoder determines a first reference picture and/or a second reference picture associated with a current picture comprising a current block.

In step 1120, the video encoder, the video encoder determines an adaptive optical model used in an optical flow based refinement based on the first reference picture and the second reference picture.

In step 1130, the video encoder, the video encoder determines an adaptive sliding window size for the current block used in the optical flow based refinement.

In step 1140, the video encoder, the video encoder derives a respective motion refinement of each subblock of the current block based on the adaptive optical model and the adaptive sliding window.

In some implementations, the optical flow based refinement is uni-directional optical flow (UDOF), and determining the adaptive optical model comprises: determining the adaptive optical model based on a sample value and gradient values of the first reference picture.

In some implementations, the optical flow based refinement is uni-directional optical flow (UDOF), determining the adaptive optical model comprises: determining the adaptive optical model as:

$$I ( t ) = I ( {t}_{0} ) - {G}_{{x}_{0}} \cdot {V}_{{x}_{0}} - {G}_{{y}_{0}} \cdot {V}_{{y}_{0}}$$

wherein I(t) represents a refined sample value of the current block at current time t, I(t₀) represents a sample value of the first reference picture at time t₀, Gₓ_{₀} and G_{y}_{₀} represent gradient values of a first prediction L₀ corresponding to the first reference picture at time t₀, (Vₓ_{₀}, V_{y}_{₀}) is the respective motion refinement.

In some implementations, deriving a respective motion refinement of each subblock of the current block comprises: deriving the respective motion refinement based on a first reference template in the first reference picture.

In some implementations, deriving a respective motion refinement based on a first reference template in the first reference picture comprises: determining the first reference template in the first reference picture at time t₀ for a neighboring reconstructed template of the current block; deriving

$${V}_{{x}_{0}}^{T} and {V}_{{y}_{0}}^{T}$$

by minimizing a difference between I^{T}(t) and

$${I}_{c u r}^{T} ;$$

$$min \{ {\sum }_{{Ω}^{T}} {( {I}_{c u r}^{T} - {I}^{T} ( {t}_{0} ) + {G}_{{x}_{0}}^{T} \cdot {V}_{{x}_{0}}^{T} + {G}_{{y}_{0}}^{T} \cdot {V}_{{y}_{0}}^{T} )}^{2} \}$$

wherein I^{T}(t) represents a refined template sample value of the current block at current time t,

$${I}_{cur}^{T}$$

represents the neighboring reconstructed template of the current block at current time t, QT represent a region in the first reference template, I^{T}(t₀) represents the first reference template at time t₀,

$${G}_{{x}_{0}}^{T} and {G}_{{y}_{0}}^{T}$$

represent gradient values of a first prediction corresponding to the first reference template, represent

$$( {V}_{{x}_{0}}^{T} , {V}_{{y}_{0}}^{T} )$$

represent a respective motion refinement of the first reference template, and deriving Vₓ_{₀} and V_{y}_{₀} as

$${V}_{{x}_{0}}^{T} and {V}_{{y}_{0}}^{T} ,$$

respectively,

$$\begin{matrix}{V}_{{x}_{0}} = {V}_{{x}_{0}}^{T} \\ {V}_{{y}_{0}} = {V}_{{y}_{0}}^{T} .\end{matrix}$$

In some implementations, the optical flow based refinement is Bi-directional optical flow (BDOF), wherein determining the adaptive optical model comprising: determining the adaptive optical model as the same as an optical model of BDOF:

$$I ( t ) = \frac{I ( {t}_{0} ) + I ( {t}_{1} )}{2} + \frac{( {G}_{{x}_{0}} - {G}_{{x}_{1}} ) \cdot {V}_{x} + ( {G}_{{y}_{0}} - {G}_{{y}_{1}} ) \cdot {V}_{y}}{2}$$

wherein I(t) represents a refined sample value of the current block at current time t, I(t₀) represents a sample value of the first reference picture at time t₀, I(t₁) represents a sample value of the second reference picture at time t₁, Gₓ_{₀} and G_{y}_{₀} represent gradient values of a first prediction L₀ corresponding to the first reference picture at time t₀, Gₓ_{₁} and G_{y}_{₁} represent gradient values of a second prediction L₁ corresponding to the second reference picture at time t₁, (Vₓ, V_{y}) is the respective motion refinement; wherein deriving a respective motion refinement of each subblock of the current block comprises: deriving the respective motion refinement based on a neighboring reconstructed template of the current block

In some implementations, deriving a respective motion refinement of each subblock of the current block comprising: determining a first reference template in the first reference picture at time t₀ and a second reference template in the second reference picture at time t₁ for a neighboring reconstructed template of the current block; and deriving

$${V}_{x}^{T} and {V}_{y}^{T}$$

by minimizing the difference between I^{T}(t) and

$${I}_{cur}^{T}$$

$$min \{ {\sum }_{{Ω}^{T}} {( {I}_{cur}^{T} - \frac{{I}^{T} ( {t}_{0} ) + {I}^{T} ( {t}_{1} )}{2} - \frac{( {G}_{{x}_{0}}^{T} - {G}_{{x}_{1}}^{T} ) \cdot {V}_{x}^{T} + ( {G}_{{y}_{0}}^{T} - {G}_{{y}_{1}}^{T} ) \cdot {V}_{y}^{T}}{2} )}^{2} \}$$

wherein I^{T}(t) represents a refined template sample value of the current block at current time t,

$${I}_{cur}^{T}$$

represents the neighboring reconstructed template of the current block at current time t, Ω^{T} represent the region in the first reference template and the second reference template, I^{T}(t₀) represents the first reference template at time t₀,

$${G}_{{x}_{0}}^{T} and {G}_{{y}_{0}}^{T}$$

represent gradient values of a first prediction corresponding to the first reference template, I^{T}(t₁) represents the second reference template at time t₁,

$${G}_{{x}_{1}}^{T} and {G}_{{y}_{1}}^{T}$$

represent gradient values of a second prediction corresponding to the second reference template,

$$( {V}_{x}^{T} , {V}_{y}^{T} )$$

represent a respective template motion refinement, and deriving Vₓ and V_{y} as

$${V}_{x}^{T} and {V}_{y}^{T} ,$$

respectively,

$$\begin{matrix}{V}_{x} = {V}_{x}^{T} \\ {V}_{y} = {V}_{y}^{T} .\end{matrix}$$

In some implementations, the first reference picture is displayed before the current picture and the second reference picture is displayed after the current picture, and wherein a first distance from the first reference picture to the current picture is different from a second distance from the second reference picture to the current picture.

In some implementations, the first reference picture and the second reference picture are displayed before the current picture.

In some implementations, the optical flow based refinement is Bi-directional optical flow (BDOF), wherein the first reference picture is displayed before the current picture and the second reference picture is displayed after the current picture, wherein determining the adaptive optical model comprising: determining the adaptive optical model as an optical model candidate selected from a group consisting of:

$$I ( t ) = \frac{I ( {t}_{0} ) + I ( {t}_{1} )}{2} + \frac{( {G}_{{x}_{0}} - {G}_{{x}_{1}} ) \cdot {V}_{x} + ( {G}_{{y}_{0}} - {G}_{{y}_{1}} ) \cdot {V}_{y}}{2} ,$$

$$I ( t ) = \frac{I ( {t}_{0} ) + ( {G}_{{x}_{0}} \cdot {V}_{{x}_{0}} + {G}_{{y}_{0}} \cdot {V}_{{y}_{0}} ) + I ( {t}_{1} )}{2} and$$

$$I ( t ) = \frac{I ( {t}_{1} ) + ( {G}_{{x}_{1}} \cdot {V}_{{x}_{1}} + {G}_{{y}_{1}} \cdot {V}_{{y}_{1}} ) + I ( {t}_{0} )}{2}$$

wherein I(t) represents a refined sample value of the current block at current time t, I(t₀) represents a sample value of the first reference picture at time t₀, I(t₁) represents a sample value of the second reference picture at time t₁, Gₓ_{₀} and G_{y}_{₀} represent gradient values of a first prediction L₀ corresponding to the first reference picture at time t₀, Gₓ_{₁} and G_{y}_{₁} represent gradient values of a second prediction L₁ corresponding to the second reference picture at time t₁, (Vₓ, V_{y}) is the respective motion refinement.

In some implementations, deriving a respective motion refinement of each subblock of the current block comprising: deriving Vₓ_{ᵢ} and V_{y}_{ᵢ} by minimizing the following cost:

$$min \{ {\sum }_{Ω} ( I ( {t}_{i} ) + {( {G}_{{x}_{i}} \cdot {V}_{{x}_{i}} + {G}_{{y}_{i}} \cdot {V}_{{y}_{i}} - I ( {t}_{1 - i} ) )}^{2} \}$$

wherein Ω represents the region in the current block, i=0 or 1.

In some implementations, deriving a respective motion refinement of each subblock of the current block comprising: determining a first reference template in the first reference picture at time t₀ and a second reference template in the first reference picture at time t₁ for a neighboring reconstructed template of the current block; and deriving

$${V}_{{x}_{i}}^{T} and {V}_{{y}_{i}}^{T}$$

by minimizing the difference between I^{T}(t) and

$${I}_{c u r}^{T} ;$$

$$min \{ {\sum }_{{Ω}^{T}} {( {I}_{c u r}^{T} - \frac{{I}^{T} ( {t}_{i} ) + ( {G}_{{x}_{i}}^{T} + {G}_{y}^{{τ}_{i}} ) + {I}^{T} ( {t}_{1 - i} )}{2} )}^{2} \}$$

wherein I^{T}(t) represents a refined template sample value of the current block at current time t,

$${I}_{c u r}^{T}$$

represents the neighboring reconstructed template of the current block at current time t, Ω^{T} represent the region in the first reference template and the second reference template, I^{T}(t₀) represents the first reference template at time t₀,

$${G}_{{x}_{0}}^{T} and {G}_{{y}_{0}}^{T}$$

present gradient values of a first prediction corresponding to the first reference template, I^{T}(t₁) represents the second reference template at time t₁,

$${G}_{{x}_{1}}^{T} and {G}_{{y}_{1}}^{T}$$

represent gradient values of a second prediction corresponding to the second reference template,

$$( {V}_{{x}_{i}}^{T} , {V}_{{y}_{i}}^{T} )$$

represent a respective template motion refinement, i=0 or 1, and deriving Vₓ and V_{y} as

$${V}_{{x}_{i}}^{T} and {V}_{{y}_{i}}^{T} ,$$

respectively,

$${V}_{x} = {V}_{{x}_{i}}^{T} \\ {V}_{y} = {V}_{{y}_{i}}^{T} .$$

In some implementations, determining the adaptive optical model as an optical model candidate comprises: deriving the optical model candidate from a bitstream. In some variants, the decoder receives the optical model candidate from a bitstream.

In some implementations, determining the adaptive optical model as an optical model candidate comprising: calculating respective template costs between a predicted template and a neighboring reconstructed template of the current block with respective optical model candidates from the group; determining a minimum template cost from the respective template costs; and selecting an optical model candidate with the minimum template cost from the respective optical model candidates as the adaptive optical model.

In some implementations, the optical flow based refinement is Bi-directional optical flow (BDOF), wherein the first reference picture is displayed before the current picture and the second reference picture is displayed after the current picture, wherein deriving a respective motion refinement of each subblock of the current block comprises: calculating a first template cost between a first predicted template and a neighboring reconstructed template of the current block without BDOF; calculating a second template cost between a second predicted template and the neighboring reconstructed template of the current block by applying BDOF to a template of the current block; in accordance with a determination that the first template cost is less than the second template cost, deriving the respective motion refinement of each subblock of the current block without applying BDOF to the current block; and in accordance with a determination that the first template cost is not less than the second template cost, deriving the respective motion refinement of each subblock of the current block by applying BDOF to the current block.

In some implementations, the first reference picture is displayed before the current picture and the second reference picture is displayed after the current picture, and a first distance from the first reference picture to the current picture is not the same as a second distance from the second reference picture to the current picture, wherein determining the adaptive optical model comprises: determining the adaptive optical model to be the same as an optical model of Bi-directional optical flow (BDOF), wherein deriving a respective motion refinement of each subblock of the current block comprises: deriving a first scaling factor and a second scaling factor based on the first distance and the second distance, deriving the respective motion refinement of each subblock of the current block based on the first scaling factor and the second scaling factor.

In some implementations, deriving the respective motion refinement of each subblock of the current block based on the first scaling factor and the second scaling factor comprising: deriving the first scaling factor and the second scaling factor as:

if abs(poc1 − poc) > abs(poc0 − poc), then
s0 = (abs(poc0 − poc) << S) / abs(poc1 −poc),
s1=(1<<S),
if abs(poc1 − poc) < abs(poc0 − poc), then
s1 = (abs(poc1 − poc) << S) / abs(poc0 − poc),
s0=(1 << S)

where abs(.) is used to calculate absolute value, s0 is the first scaling factor, s1 is the second scaling factor, S is the shift number to represent the scaling factors with integer, poc represents a picture order count (POC) of the current picture, poc1 represents a POC of the first reference picture, poc2 represents a POC of the second reference picture.

In some implementations, deriving the respective motion refinement of each subblock of the current block based on the first scaling factor and the second scaling factor comprising: calculating first gradient values

$$\frac{\partial {I}^{( 0 )}}{\partial x} ( i , j ) and \frac{\partial {I}^{( 0 )}}{\partial y} ( i , j )$$

for a first prediction L₀ and second gradient values

$$\frac{\partial {I}^{( 1 )}}{\partial x} ( i , j ) and \frac{\partial {I}^{( 1 )}}{\partial y} ( i , j )$$

for a second prediction L₁ by the flowing equations:

$$\frac{\partial {I}^{( k )}}{\partial x} ( i , j ) = ( ( {I}^{( k )} ( i + 1 , j ) ≫ shift1 ) - ( {I}^{( k )} ( i - 1 , j ) ≫ shift1 ) ) ≪ S \\ \frac{\partial {I}^{( k )}}{\partial y} ( i , j ) = ( ( {I}^{( k )} ( i , j + 1 ) ≫ shift1 ) - ( {I}^{( k )} ( i , j - 1 ) ≫ shift1 ) ) ≪ S$$

where I⁽⁰⁾(i, j) is a prediction sample at sample location (i,j) of the first prediction L₀, and I⁽¹⁾(i, j) is a prediction sample at the sample location (i,j) of the second prediction Li, wherein the first prediction L₀ corresponding to the first reference picture and the second prediction L₁ corresponding to the second reference picture, where k=0 or 1, shift1 is an integer;
calculating an internal parameter θ(i,j) by:

$$θ ( i , j ) = ( ( {I}^{( 1 )} ( i , j ) ≫ {n}_{b} ) - ( {I}^{( 0 )} ( i , j ) ≫ {n}_{b} ) ) ≪ S$$

where θ(i,j) is a difference between the first prediction L₀ and the second prediction Li, wherein the method further comprising: calculating a prediction sample pred_{BDOF}(x, y) based on the respective motion refinements:

$${pred}_{BDOF} ( x , y ) = ( ( {I}^{( 0 )} ( x , y ) + {I}^{( 1 )} ( x , y ) + {o}_{offset} ) ≪ S + b ( x , y ) ) ≫ ( shift + S )$$

wherein b(x, y) is calculated based on the motion refinements

$$\frac{\partial {I}^{( 0 )}}{\partial x} ( i , j ) , \frac{\partial {I}^{( 0 )}}{\partial y} ( i , j ) , \frac{\partial {I}^{( 1 )}}{\partial x} ( i , j ) and \frac{\partial {I}^{( 1 )}}{\partial y} ( i , j ) .$$

In some implementations, deriving the respective motion refinement of each subblock of the current block based on the first scaling factor and the second scaling factor comprising: scaling the motion refinements by the first scaling factor and the second scaling factor:

$${v}_{x 0} = ( ( 1 ≪ S ) * {v}_{x} + ( 1 ≪ ( S - 1 ) ) - ( ( 1 ≪ S ) * {v}_{x} \geq 0 ) ) ≫ S \\ {v}_{y 0} = ( ( 1 ≪ S ) * {v}_{y} + ( 1 ≪ ( S - 1 ) ) - ( ( 1 ≪ S ) * {v}_{y} \geq 0 ) ) ≫ S \\ {v}_{x 1} = ( ( 1 ≪ S ) * {v}_{x 1} + ( 1 ≪ ( S - 1 ) ) - ( ( 1 ≪ S ) * {v}_{x 1} \geq 0 ) ) ≫ S \\ {v}_{y 1} = ( ( 1 ≪ S ) * {v}_{y 1} + ( 1 ≪ ( S - 1 ) ) - ( ( 1 ≪ S ) * {v}_{y 1} >= 0 ) ) >> S$$

wherein vₓ₀ and v_{y0} are motion refinements for the first reference picture, vₓ₁ and v_{y1} are motion refinements for the second reference picture, wherein the method further comprising: calculating an adjustment value for each sample of the current block:

$$b ( x , y ) = rnd ( \frac{\begin{matrix}( {v}_{x 1} \cdot \frac{\partial {I}^{( 1 )} ( x , y )}{\partial x} - {v}_{x 0} \cdot \frac{\partial {I}^{( 0 )} ( x , y )}{\partial x} + \\ {v}_{y 1} \cdot \frac{\partial {I}^{( 1 )} ( x , y )}{\partial y} - {v}_{y 0} \cdot \frac{\partial {I}^{( 0 )} ( x , y )}{\partial y} + 1 )\end{matrix}}{2} ) ,$$

wherein rnd( ) is a rounding function to return an integral value that is nearest to an argument.

In some implementations, determining an adaptive sliding window size for the current block comprises: deriving the adaptive sliding window size from a bitstream. In some variants, the decoder receives the adaptive sliding window size from a bitstream.

In some implementations, the optical flow based refinement process is BDOF, wherein determining an adaptive sliding window size for the current block comprising: determining a first reference template in the first reference picture and a second reference template in the second reference picture for a neighboring reconstructed template of the current block; determining one or more sliding window size candidates; for each sliding window size candidate: deriving a predicted block by applying BDOF and the second reference template; and calculating a template matching cost between the predict block and the current block; and selecting a sliding window size candidate with a minimum template matching cost from the one or more sliding window size candidates as the adaptive sliding window size.

In some implementations, a chroma format of the current block is 4:0:0, 4:2:0, 4:2:2, or 4:4:4.

In some implementations, determining the adaptive optical model as an optical model candidate comprising: calculating respective template costs between a predicted template and a neighboring reconstructed template of the current block with respective optical model candidates from the group; determining a minimum template cost from the respective template costs; selecting an optical model candidate with the minimum template cost from the respective optical model candidates as the adaptive optical model.

In some implementations, the method further encodes the optical model candidate into a bitstream.

In some implementations, the optical flow based refinement process is BDOF, wherein determining an adaptive sliding window size for the current block comprising: determining a first reference template in the first reference picture and a second reference template in the second reference picture for a neighboring reconstructed template of the current block; determining one or more sliding window size candidates; for each sliding window size candidate: deriving a predict block by applying BDOF to the first reference template and the second reference template; and calculating a template matching cost between the predict block and the current block; and selecting a sliding window size candidate with a minimum template matching cost from the one or more sliding window size candidates as the adaptive sliding window size.

In some implementations, the method further encodes the adaptive sliding window size into a bitstream.

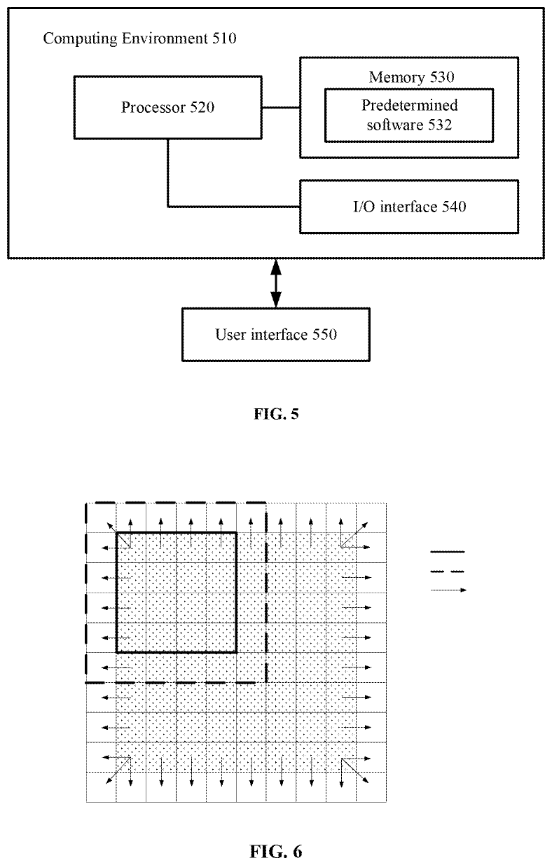

FIG. 5 shows a computing environment 510 coupled with a user interface 550. The computing environment 510 can be part of a data processing server. The computing environment 510 includes a processor 520, a memory 530, and an Input/Output (I/O) interface 540.

The processor 520 typically controls overall operations of the computing environment 510, such as the operations associated with display, data acquisition, data communications, and image processing. The processor 520 may include one or more processors to execute instructions to perform all or some of the steps in the above-described methods. Moreover, the processor 520 may include one or more modules that facilitate the interaction between the processor 520 and other components. The processor may be a Central Processing Unit (CPU), a microprocessor, a single chip machine, a Graphical Processing Unit (GPU), or the like.

The memory 530 is configured to store various types of data to support the operation of the computing environment 510. The memory 530 may include predetermined software 532. Examples of such data includes instructions for any applications or methods operated on the computing environment 510, video datasets, image data, etc. The memory 530 may be implemented by using any type of volatile or non-volatile memory devices, or a combination thereof, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic or optical disk.

The I/O interface 540 provides an interface between the processor 520 and peripheral interface modules, such as a keyboard, a click wheel, buttons, and the like. The buttons may include but are not limited to, a home button, a start scan button, and a stop scan button. The I/O interface 540 can be coupled with an encoder and decoder.

In an embodiment, there is also provided a non-transitory computer-readable storage medium comprising a plurality of programs, for example, in the memory 530, executable by the processor 520 in the computing environment 510, for performing the above-described methods and/or storing a bitstream generated by the encoding method described above or a bitstream to be decoded by the decoding method described above. In one example, the plurality of programs may be executed by the processor 520 in the computing environment 510 to receive (for example, from the video encoder 20 in FIG. 2) a bitstream or data stream including encoded video information (for example, video blocks representing encoded video frames, and/or associated one or more syntax elements, etc.), and may also be executed by the processor 520 in the computing environment 510 to perform the decoding method described above according to the received bitstream or data stream. In another example, the plurality of programs may be executed by the processor 520 in the computing environment 510 to perform the encoding method described above to encode video information (for example, video blocks representing video frames, and/or associated one or more syntax elements, etc.) into a bitstream or data stream, and may also be executed by the processor 520 in the computing environment 510 to transmit the bitstream or data stream (for example, to the video decoder 30 in FIG. 3). Alternatively, the non-transitory computer-readable storage medium may have stored therein a bitstream or a data stream comprising encoded video information (for example, video blocks representing encoded video frames, and/or associated one or more syntax elements, etc.) generated by an encoder (for example, the video encoder 20 in FIG. 2) using, for example, the encoding method described above for use by a decoder (for example, the video decoder 30 in FIG. 3) in decoding video data. The non-transitory computer-readable storage medium may be, for example, a ROM, a Random Access Memory (RAM), a CD-ROM, a magnetic tape, a floppy disc, an optical data storage device or the like.

In an embodiment, there is provided a bitstream generated by the encoding method described above or a bitstream to be decoded by the decoding method described above. In an embodiment, there is provided a bitstream comprising encoded video information generated by the encoding method described above or encoded video information to be decoded by the decoding method described above.

In an embodiment, the is also provided a computing device comprising one or more processors (for example, the processor 520); and the non-transitory computer-readable storage medium or the memory 530 having stored therein a plurality of programs executable by the one or more processors, wherein the one or more processors, upon execution of the plurality of programs, are configured to perform the above-described methods.

In an embodiment, there is also provided a computer program product having instructions for storage or transmission of a bitstream comprising encoded video information generated by the encoding method described above or encoded video information to be decoded by the decoding method described above. In an embodiment, there is also provided a computer program product comprising a plurality of programs, for example, in the memory 530, executable by the processor 520 in the computing environment 510, for performing the above-described methods. For example, the computer program product may include the non-transitory computer-readable storage medium.

In an embodiment, the computing environment 510 may be implemented with one or more ASICs, DSPs, Digital Signal Processing Devices (DSPDs), Programmable Logic Devices (PLDs), FPGAs, GPUs, controllers, micro-controllers, microprocessors, or other electronic components, for performing the above methods.

In an embodiment, there is also provided a method of storing a bitstream, comprising storing the bitstream on a digital storage medium, wherein the bitstream comprises encoded video information generated by the encoding method described above or encoded video information to be decoded by the decoding method described above.

In an embodiment, there is also provided a method for transmitting a bitstream generated by the encoder described above. In an embodiment, there is also provided a method for receiving a bitstream to be decoded by the decoder described above.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for video decoding, comprising:
determining a first reference picture and/or a second reference picture associated with a current picture comprising a current block;
determining an adaptive optical model used in an optical flow based refinement based on the first reference picture and/or the second reference picture;
determining an adaptive sliding window size for the current block used in the optical flow based refinement; and
deriving a respective motion refinement of each subblock of the current block based on the adaptive optical model and the adaptive sliding window.

2. The method of claim 1, wherein:
the optical flow based refinement is uni-directional optical flow (UDOF);
determining the adaptive optical model comprises:
determining the adaptive optical model based on a sample value and gradient values of the first reference picture; and
deriving a respective motion refinement of each subblock of the current block comprises:
deriving the respective motion refinement based on a first reference template in the first reference picture.

3-5. (canceled)

6. The method of claim 1, wherein the optical flow based refinement is Bi-directional optical flow (BDOF), wherein determining the adaptive optical model comprising:
determining the adaptive optical model as the same as an optical model of BDOF:
$$I ( t ) = \frac{I ( {t}_{0} ) + I ( {t}_{1} )}{2} + \frac{( {G}_{{x}_{0}} - {G}_{{x}_{1}} ) \cdot {V}_{x} + ( {G}_{{y}_{0}} - {G}_{{y}_{1}} ) \cdot {V}_{y}}{2}$$
wherein I(t) represents a refined sample value of the current block at current time t, I(t₀) represents a sample value of the first reference picture at time t₀, I(t₁) represents a sample value of the second reference picture at time t₁, Gₓ_{₀} and G_{y}_{₀} represent gradient values of a first prediction corresponding to the first reference picture at time t₀, Gₓ_{₁} and G_{y}_{₁} represent gradient values of a second prediction corresponding to the second reference picture at time t₁, (Vₓ,V_{y}) is the respective motion refinement;
wherein deriving a respective motion refinement of each subblock of the current block comprises:
deriving the respective motion refinement based on a neighboring reconstructed template of the current block.

7-14. (canceled)

15. The method of claim 1, wherein the optical flow based refinement is Bi-directional optical flow (BDOF), and the first reference picture is displayed before the current picture and the second reference picture is displayed after the current picture, and
wherein deriving a respective motion refinement of each subblock of the current block comprises:
calculating a first template cost between a first predicted template and a neighboring reconstructed template of the current block without BDOF;
calculating a second template cost between a second predicted template and the neighboring reconstructed template of the current block by applying BDOF to a template of the current block;
in accordance with a determination that the first template cost is less than the second template cost, deriving the respective motion refinement of each subblock of the current block without applying BDOF to the current block; and
in accordance with a determination that the first template cost is not less than the second template cost, deriving the respective motion refinement of each subblock of the current block by applying BDOF to the current block.

16-20. (canceled)

21. The method of claim 1, wherein the optical flow based refinement is BDOF, wherein determining an adaptive sliding window size for the current block comprises:
determining a first reference template in the first reference picture and a second reference template in the second reference picture for a neighboring reconstructed template of the current block;
determining one or more sliding window size candidates;
for each sliding window size candidate:
deriving a predicted block by applying BDOF; and
calculating a template matching cost between the predict block and the current block; and
selecting a sliding window size candidate with a minimum template matching cost from the one or more sliding window size candidates as the adaptive sliding window size.

22. The method of claim 1, wherein a chroma format of the current block is 4:2:2.

23. A method for video encoding, comprising
determining a first reference picture and/or a second reference picture associated with a current picture comprising a current block;
determining an adaptive optical model used in an optical flow based refinement based on the first reference picture and/or the second reference picture;
determining an adaptive sliding window size for the current block used in the optical flow based refinement; and
deriving a respective motion refinement of each subblock of the current block based on the adaptive optical model and the adaptive sliding window.

24. The method of claim 23, wherein;
the optical flow based refinement is uni-directional optical flow (UDOF), and determining the adaptive optical model comprises:
determining the adaptive optical model based on a sample value and gradient values of the first reference picture; and
deriving a respective motion refinement of each subblock of the current block comprises:
deriving the respective motion refinement based on a first reference template in the first reference picture.

25-27. (canceled)

28. The method of claim 23, wherein the optical flow based refinement is Bi-directional optical flow (BDOF), wherein determining the adaptive optical model comprising:
determining the adaptive optical model as the same as an optical model of BDOF:
$$I ( t ) = \frac{I ( {t}_{0} ) + I ( {t}_{1} )}{2} + \frac{( {G}_{{x}_{0}} - {G}_{{x}_{1}} ) \cdot {V}_{x} + ( {G}_{{y}_{0}} - {G}_{{y}_{1}} ) \cdot {V}_{y}}{2}$$
wherein I(t) represents a refined sample value of the current block at current time t, I(t₀) represents a sample value of the first reference picture at time t₀, I(t₁) represents a sample value of the second reference picture at time t₁, Gₓ_{₀} and G_{y}_{₀} represent gradient values of a first prediction corresponding to the first reference picture at time t₀, Gₓ_{₁} and G_{y}_{₁} represent gradient values of a second prediction corresponding to the second reference picture at time t₁, (Vₓ,V_{y}) is the respective motion refinement;
wherein deriving a respective motion refinement of each subblock of the current block comprises:
deriving the respective motion refinement based on a neighboring reconstructed template of the current block.

29-36. (canceled)

37. The method of claim 23, wherein the optical flow based refinement is Bi-directional optical flow (BDOF), and the first reference picture is displayed before the current picture and the second reference picture is displayed after the current picture, and
wherein deriving a respective motion refinement of each subblock of the current block comprises:
calculating a first template cost between a first predicted template and a neighboring reconstructed template of the current block without BDOF;
calculating a second template cost between a second predicted template and the neighboring reconstructed template of the current block by applying BDOF to a template of the current block;
in accordance with a determination that the first template cost is less than the second template cost, deriving the respective motion refinement of each subblock of the current block without applying BDOF to the current block; and
in accordance with a determination that the first template cost is not less than the second template cost, deriving the respective motion refinement of each subblock of the current block by applying BDOF to the current block.

38-41. (canceled)

42. The method of claim 23, wherein the optical flow based refinement process is BDOF, wherein determining an adaptive sliding window size for the current block comprising:
determining a first reference template in the first reference picture and a second reference template in the second reference picture for a neighboring reconstructed template of the current block;
determining one or more sliding window size candidates;
for each sliding window size candidate:
deriving a predict block by applying BDOF to the first reference template and the second reference template; and
calculating a template matching cost between the predict block and the current block; and
selecting a sliding window size candidate with a minimum template matching cost from the one or more sliding window size candidates as the adaptive sliding window size.

43. (canceled)

44. The method of claim 23, wherein a chroma format of the current block is 4:2:2.

45. An apparatus for video decoding, comprising:
one or more processors; and
a memory coupled to the one or more processors and configured to store instructions executable by the one or more processors,
wherein the one or more processors, upon execution of the instructions, are configured to perform the method of claim 1.

46. A non-transitory computer-readable storage medium for storing a bitstream generated by the method claim 23.

47. A method for storing a bitstream, comprising:
generating a bitstream by performing the method claim 23; and
storing the bitstream.

48. (canceled)

49. (canceled)

50. The method of claim 1, wherein a chroma format of the current block is 4:4:4.

51. The method of claim 23, wherein a chroma format of the current block is 4:4:4.

52. An apparatus for video encoding, comprising:
one or more processors; and
a memory coupled to the one or more processors and configured to store instructions executable by the one or more processors,
wherein the one or more processors, upon execution of the instructions, are configured to perform the method of claim 8.

53. The method of claim 47, wherein a chroma format of video data is 4:2:2.

54. The method of claim 47, wherein a chroma format of video data is 4:4:4.
